(19) United States
(12) Patent Application Publication
(10) Pub. No.: US 2015/0336022 A1
(43) Pub. Date: Nov. 26, 2015

(54) INTEGRATED RECYCLING SYSTEM AND METHODS FOR USE OF SLUDGE

(71) Applicant: Georgia-Pacific LLC, Atlanta, GA (US)

(72) Inventors: Paul Topping, Smyrna, GA (US); Subrata Sen, Kennesaw, GA (US)

(73) Assignee: Georgia-Pacific LLC, Atlanta, GA (US)

(21) Appl. No.: 14/711,930

(22) Filed: May 14, 2015

Related U.S. Application Data
(60) Provisional application No. 62/001,609, filed on May 21, 2014.

(51) Int. Cl. B01D 3/00

(52) U.S. Cl. CPC B01D 3/00

(57) ABSTRACT

Methods are provided for reuse of a sludge from a waste fiber supply including an organic fraction and an inorganic fraction. Generally, methods include converting the sludge by burning the sludge to remove a majority of the organic fraction and produce an ash with inorganic materials in an amount of at least about 80% by weight of the ash and adding the ash to a plastic pyrolysis system in an effective amount to remove at least a portion of one or more contaminants from a plastic feed stream of the plastic pyrolysis system. Integrated recycling systems also are provided and include a fiber recovery system; a means for at least partially dewatering a sludge; a burner; and a pyrolyzer.

### CROSS-REFERENCE TO RELATED APPLICATIONS

This application claims priority to U.S. Provisional Application No. 62/001,609, filed on May 21, 2014, the disclosure of which is incorporated by reference herein in its entirety.

### TECHNICAL FIELD

Embodiments of the present application are directed generally to integrated recycling systems and methods including a novel reuse of sludge from a waste fiber supply. In particular, embodiments of the present application are directed to adding an ash produced from the sludge to a plastic pyrolysis system for reduction or removal of contaminants.

### BACKGROUND

Paper recycling processes are effective at converting waste paper into usable paper products, benefitting both the environment and society by reducing the need to cut down trees for virgin pulp. About two-thirds of the paper that is recycled can be recovered as a usable fiber; however, the remaining one-third is a sludge of waste solids. The waste solids include both organic components (e.g., cellulosic particles referred to as “fines”) and inorganic components (e.g., from paper fillers and other contaminants).

The waste solids generally are not suitable for use in manufacturing recycled paper products and generally are disposed of using various methods (including landfilling, incinerating, and dispersing on land). For example, the waste solids may be converted to ash that is landfilled, incinerated, or spread on land; however, increasing costs for disposal and concerns regarding environmental sustainability associated with such methods have made it more desirable to develop processes and systems for reusing the ash. Thus, there exists a need for improved methods and systems for practical applications of rejected wastepaper materials, such as sludge.

### SUMMARY

Methods are provided for reuse of sludge from a waste fiber supply including an organic fraction and an inorganic fraction. Embodiments of the methods include converting the sludge by burning the sludge to remove a majority of the organic fraction and produce an ash with inorganic materials in an amount of at least about 80% by weight of the ash, and adding the ash to a plastic pyrolysis system in an effective amount to remove at least a portion of one or more contaminants from a plastic feed stream of the plastic pyrolysis system.

Embodiments of integrated recycling systems also are provided, including a fiber recovery system for treating a waste fiber supply to produce at least a plastic portion, a fiber portion, and a sludge portion; a means for at least partially dewatering the sludge portion to produce a partially dewatered sludge; a burner for converting the partially dewatered sludge into an ash including inorganic materials in an amount of at least about 80% by weight of the ash; and a pyrolyzer configured to pyrolyze a mixture of the plastic portion and at least a portion of the ash.

### BRIEF DESCRIPTION OF THE DRAWINGS

FIG. 1 is a schematic illustration of an integrated recycling system according to an embodiment.

### DETAILED DESCRIPTION

Embodiments of the present description include methods and systems for reuse of sludge, particularly sludges from a waste fiber supply in a pulp and paper mill.

The term “waste fiber” or “waste paper” are used interchangeably to refer to paper or cardboard-based materials from which recycled fiber can be recovered for re-use in manufacture of paper-based products. “Recycled” fiber thus refers to fiber materials that have previously been used in a paper or cardboard product.

When recovering recycled fiber from a waste paper supply, the waste paper is separated from other types of waste materials present in the waste paper supply, non-limiting examples of which may include plastics and metals. The waste paper then is subjected to a cleaning process in order to decolor and deink the fibers and remove impurities. Greater than about 50% by weight of the waste paper supply generally may be recovered in a fiber stream that is suitable for re-use. The remaining portion of the waste paper is transported with the waste water; which is discharged to the waste water treatment system. In that system, solids are typically separated by gravitational settling, which often is aided by the addition of chemicals that promote settling. The solids recovered are referred to as “sludge” and have a relatively high water content. For example, the solids content of the sludge may be from about 4% to about 12% by weight prior to undergoing any further dewatering processes. The sludge may comprise, for example, the unusable portion of deinked papers which comprise both an organic fraction and an inorganic fraction. The terms “deinking” or “deinked” refer to part of the recycling process in which the printing ink and other contaminants are removed from waste paper.

The sludge may undergo further processing to reduce the water content. For example, in one embodiment the process includes dewatering the sludge to reduce its water content and increase the waste solids content to from about 5% to about 60% by weight of the partially dewatered sludge. For example, in embodiments the sludge may be dewatered to increase the waste solids content to greater than about 40% by weight of the sludge.

The sludge (or partially dewatered sludge) may be converted to a reusable product in the form of an ash by burning the sludge at a sufficiently high temperature to remove a majority of the organic fraction (e.g., cellulose fines, polymers, inks, adhesives and the like) from the sludge. For example, the step of converting the sludge may be performed at a temperature of about 1375° C. to about 1900° C., which is effective to remove a majority of the organic fraction of the waste solids. In embodiments, the step of converting the sludge further may also comprise grinding the ash such that greater than about 60% of particles have an average diameter smaller than about 75 microns, greater than about 70% of particles have an average diameter smaller than about 75 microns, or greater than about 80% of particles have an average diameter smaller than about 75 microns.

“Ash”, as used herein, refers to the composition that remains after burning the sludge and comprises the inorganic fraction of the waste solids. For example, the ash can include calcium oxides (e.g., precipitated calcium carbonate, ground calcium carbonate, gypsum), titanium dioxide, clay, alumina, silica, magnesium aluminum silicate, hydrated aluminum silicate, barium silicate, calcium silicate, magnesium silicate, strontium silicate, talc, mica, kaolin clay, sericite, muscovite, lepidolite, biotite, vermiculite, zeolite, barium sulfate, calcined calcium sulfate, hydroxyapatite, ceramic powder, colloidal silicone dioxide, boron nitride, or any combination thereof.

The inorganic fraction may be present in the ash in an amount of at least about 80% by weight of the ash, at least about 85% by weight of the ash, at least about 90% by weight of the ash, at least about 95% by weight of the ash, at least about 97% by weight of the ash, or at least about 99% by weight of the ash. The organic fraction may be present in the ash in an amount of less than about 10% by weight of the ash, less than about 5% by weight of the ash, less than about 3% by weight of the ash, or less than about 1% by weight of the ash. For example, in embodiments the ash may be substantially free of an organic fraction. As used herein,

“substantially free” means that loss on ignition is less than 1.5%.

Rather than disposing of the ash in landfills or via other methods, the ash may be added to a plastic pyrolysis system used to convert a plastic feed stream (e.g., plastics separated from the waste paper supply, residual plastics from material recovery facilities, or from other sources) into one or more re-usable products or intermediates that may be converted into re-usable products. The inorganic fraction of the ash is particularly effective for use as an absorbent, for example, in reducing or removing contaminants from the plastic feed stream, non-limiting examples of which include chlorine, mercury, sulfur, and combinations thereof. Thus, in embodiments the ash may be added to the plastic feed stream upstream of the plastic pyrolysis system or directly to the plastic pyrolysis system to reduce and/or eliminate emissions of one or more contaminants from the plastic pyrolysis system.

The ash may be added to the plastic pyrolysis system in an effective amount to remove at least a portion of one or more contaminants from a plastic feed stream of the plastic pyrolysis system. An effective amount, as used herein, may be characterized by a stoichiometric ratio of the ash to the one or more contaminants in the plastic feed stream of about 0.5:1 to about 5:1, or more particularly, about 1:1 to about 4:1. For example, in embodiments where the plastic feed stream comprises plastic in an amount from about 50% to about 90% by weight of the plastic feed stream, an effective amount of ash is from about 3% to about 6% by weight of the plastic feed stream.

The primary reactions between the ash and contaminants can be further understood by the following exemplary reactions:

—(CH₂—CHCl)ₙ—→—(CH═CH)ₙ—+nHCl (T˜300° C., time=30-60 min)

2HCl+CaO→CaCl₂+H₂O

CaCO₃+2HCl→CaCl₂+H₂O+CO₂

Use of ash as a sorbent in this manner is compatible with a variety of plastic pyrolysis processes and apparatus, including but not limited to those described in the following patents: EP20030733683, WO2003104354 A1, WO2013015819 A1, U.S. Pat. NO. 6,150,577 A, EP1577366 A2 and U.S. Pat. No. 7,892,500 B2, the relevant portions of which are incorporated herein by reference.

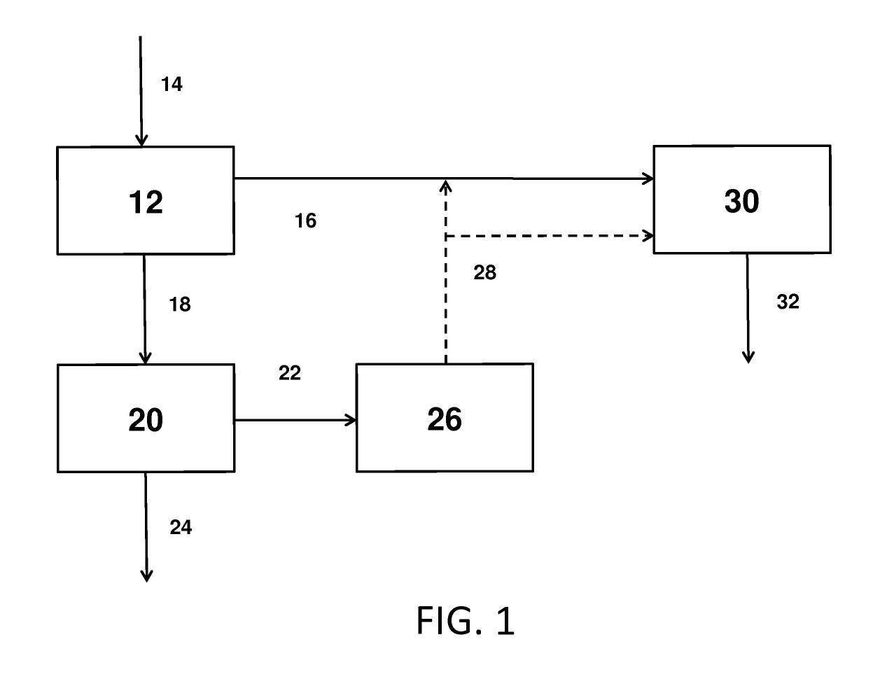

In another aspect, an integrated recycling system is provided, an embodiment of which is illustrated in FIG. 1. The integrated recycling system 10 may include a separating means 12, a fiber recovery system 20, a conversion means 26, and a plastic pyrolyzer 30.

The separating means 12 may be any type of separation device effective at removing plastics and/or other materials from a waste fiber supply 14. For example, the separating means 12 may be used to separate the waste fiber supply 14 into a plastic stream 16 and a fiber stream 18. In embodiments, the separation device may also be effective at separating other contaminants from the waste fiber supply stream 14 (e.g., glass, metals, and the like), thereby enabling use of lower quality sources of waste fiber supply than currently are used in most recycling facilities. In embodiments, the separating means 12 may be a trommel, various kinds of pulpers, or an autoclave.

The fiber recovery system 20 facilitates recovery of reusable fiber 24 from the fiber stream 18, which includes at least a portion of a feed source of printing and writing papers so that active minerals are present. Various fiber recovery systems 20 are known and generally include one or more cleaners, deinkers, clarifiers, and the like. In embodiments, the fiber recovery system 20 include a separator for recovering the pulp suitable for use in making paper (i.e., long fibers) while from other solids, such as short fibers and inorganic materials not fixed to long fibers. These solids are separated from the waste water in a clarifier and are then converted in the combustor 26. Thus, the sludge 22 resulting from the treatment of the fiber stream 18 may be collected at one or more stages from the fiber recovery system 20, particularly from the primary clarifier (at which point the sludge frequently is referred to as a deinked secondary fiber sludge). A means for at least partially dewatering the sludge also may be included as a part of the fiber recovery system or as part of the integrated recycling system. For example, a means for at least partially dewatering the sludge may include a mechanical press, screw press, belt filter, plate and frame filter, or centrifuge.

The sludge 22 is transferred from the fiber recovery system 20 to a conversion means 26 for converting at least a portion of the sludge 22 into ash 28. In embodiments, the conversion means 26 is a burner or other suitable combustor capable of operating at a sufficiently high temperature for removal of the organic fraction of the waste solids. In embodiments, the conversion means 26 also may comprise a grinder or other suitable means for reducing the average particle size of the ash 28.

The integrated recycling system 10 further comprises a pyrolyzer 30 configured to pyrolyze the plastic stream 16 separated from the waste fiber supply 14 and/or plastic streams obtained from other sources. The ash 28 may be added directly to the pyrolyzer 30 via a different inlet than that used to introduce the plastic stream 16 into the pyrolyzer 30, or may be added directly to the plastic stream 16 prior to entering the pyrolyzer 30. The pyrolyzer 30 converts the plastic stream 16 into one or more products suitable for re-use or intermediates suitable for making more valuable products.

In embodiments the integrated recycling system may include additional components for conversion of the recovered fiber and pyrolysis products downstream of the fiber recovery system and pyrolyzer, respectively. For example, the recovered fiber may be used to manufacture paper-based products and the pyrolysis products may be converted to fuels and the like.

In another aspect, the integrated recycling system may further include one or more boilers for converting one or more products of the integrated recycling system into energy. Advantageously, the energy produced by such byproducts may be used to supply the energy required for operating the integrated recycling system, thereby improving the overall energy efficiency and sustainability of the system.

Embodiments of the present disclosure further include any one or more of the following paragraphs:
1. A method for reuse of a sludge comprising:
   providing a sludge from a waste fiber supply comprising an organic fraction and an inorganic fraction;
   converting the sludge by burning the sludge to remove a majority of the organic fraction and produce an ash comprising inorganic materials in an amount of at least about 80% by weight of the ash;
   adding the ash to a plastic pyrolysis system in an effective amount to remove at least a portion of one or more contaminants from a plastic feed stream of the plastic pyrolysis system.
2. The method of paragraph 1, wherein the one or more contaminants are selected from the group consisting of chlorine, mercury, sulfur, and combinations thereof.
3. The method of paragraph 1, wherein the inorganic materials are present in the ash in an amount of at least about 85% by weight of the ash.
4. The method of paragraph 1, wherein the inorganic materials are present in the ash in an amount of at least about 90% by weight of the ash.
5. The method of paragraph 1, wherein the inorganic materials comprise calcium oxide, alumina, silica, or a combination thereof.
6. The method of paragraph 1, wherein the organic materials are present in the ash in an amount of less than about 1.0% by weight of the ash.
7. The method of paragraph 1, wherein the ash is substantially free of organic materials.
8. The method of paragraph 1, wherein the step of converting the sludge is conducted at a temperature of about 1375 to about 1900° C.
9. The method of paragraph 1, wherein the step of converting the sludge further comprises grinding the ash to reduce its average diameter to less than 75 microns.
10. The method of paragraph 1, wherein the effective amount is characterized by a stoichiometric ratio of the ash to the one or more contaminants in the plastic feed stream of about 0.5:1 to about 5:1.
11. The method of paragraph 1, wherein the effective amount of ash is characterized by a stoichiometric ratio of the ash to the one or more contaminants in the plastic feed stream of about 1:1 to about 4:1.
12. The method of paragraph 1, wherein the plastic feed stream comprises plastic in an amount from about 50% to about 90% by weight of the plastic feed stream and the effective amount of ash is about 3% to about 6% by weight of the plastic feed stream.
13. The method of paragraph 1, wherein the ash is added to the plastic feed stream upstream of the plastic pyrolysis system.
14. The method of paragraph 1, wherein the ash is added directly to the plastic pyrolysis system.
15. The method of paragraph 1, wherein the waste fiber supply is at a pulp and paper mill.
16. The method of paragraph 1, further comprising separating a plastic portion and a fiber portion from the waste fiber supply to form the plastic feed stream, a recovered fiber stream, and the sludge.
17. The method of paragraph 16, wherein the sludge comprises waste solids from the recovered fiber stream.
18. The method of paragraph 17, further comprising dewatering the waste solids to concentrate the sludge to a solids content of greater than about 40% by weight of the sludge.
19. The method of paragraph 15, wherein the sludge comprises a deinked secondary paper sludge.
21. The method of paragraph 16, wherein the recovered fiber stream comprises at least about 50% by weight of the waste fiber supply.
22. The method of paragraph 16, further comprising using the recovered fiber stream to produce one or more recycled paper products.
23. The method of paragraph 1, wherein the plastic pyrolysis system converts the plastic feed stream into one or more products suitable for use as a fuel.
24. The method of paragraph 1, wherein the method is effective at reducing and/or eliminating emissions of the one or more contaminants from the plastic pyrolysis system.
25. An integrated recycling system comprising:
   a fiber recovery system for treating a waste fiber supply to produce at least a plastic portion, a fiber portion, and a sludge portion;
   a means for at least partially dewatering the sludge portion to produce a partially dewatered sludge;
   a burner for converting the partially dewatered sludge into an ash comprising inorganic materials in an amount of at least about 80% by weight of the ash; and
   a pyrolyzer configured to pyrolyze a mixture of the plastic portion and at least a portion of the ash.
26. The system of paragraph 25, wherein the fiber recovery system comprises a rotoclave for separating the plastic portion and the fiber portion from the waste fiber supply.
27. The system of paragraph 25, wherein the fiber recovery system comprises a cleaner, deinker, clarifier, or a combination thereof.
28. The system of paragraph 25, wherein the fiber recovery system comprises a separator for removing short fibers and inorganic materials not fixed to long fibers, the long fibers being suitable for use in one or more recycled paper products.
29. The system of paragraph 25, wherein the means for at least partially dewatering the sludge portion comprises a mechanical press.
30. The system of paragraph 25, further comprising a grinder for reducing an average diameter of the ash.
31. The system of paragraph 25, further comprising one or more boilers for converting one or more byproducts of the integrated recycling system into energy.
32. The system of paragraph 25, wherein the system is onsite at a pulp and paper mill.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A method for reuse of a sludge comprising:
providing a sludge from a waste fiber supply comprising an organic fraction and an inorganic fraction;
converting the sludge by burning the sludge to remove a majority of the organic fraction and produce an ash comprising inorganic materials in an amount of at least about 80% by weight of the ash;
adding the ash to a plastic pyrolysis system in an effective amount to remove at least a portion of one or more contaminants from a plastic feed stream of the plastic pyrolysis system.

2. The method of claim 1, wherein the one or more contaminants are selected from the group consisting of chlorine, mercury, sulfur, and combinations thereof.

3. The method of claim 1, wherein the inorganic materials are present in the ash in an amount of at least about 85% by weight of the ash.

4. The method of claim 1, wherein the inorganic materials comprise calcium oxide, alumina, silica, or a combination thereof.

5. The method of claim 1, wherein the organic materials are present in the ash in an amount of less than about 1.0% by weight of the ash.

6. The method of claim 1, wherein the step of converting the sludge is conducted at a temperature of about 1375 to about 1900° C.

7. The method of claim 1, wherein the step of converting the sludge further comprises grinding the ash to reduce its average diameter to less than 75 microns.

8. The method of claim 1, wherein the effective amount of ash is characterized by a stoichiometric ratio of the ash to the one or more contaminants in the plastic feed stream of about 0.5:1 to about 5:1.

9. The method of claim 1, wherein the plastic feed stream comprises plastic in an amount from about 50% to about 90% by weight of the plastic feed stream and the effective amount of ash is about 3% to about 6% by weight of the plastic feed stream.

10. The method of claim 1, further comprising separating a plastic portion and a fiber portion from the waste fiber supply to form the plastic feed stream, a recovered fiber stream, and the sludge.

11. The method of claim 10, wherein the sludge comprises waste solids from the recovered fiber stream.

12. The method of claim 11, further comprising dewatering the waste solids to concentrate the sludge to a solids content of greater than about 40% by weight of the sludge.

13. The method of claim 10, wherein the recovered fiber stream comprises at least about 50% by weight of the waste fiber supply.

14. An integrated recycling system comprising:
a fiber recovery system for treating a waste fiber supply to produce at least a plastic portion, a fiber portion, and a sludge portion;
a means for at least partially dewatering the sludge portion to produce a partially dewatered sludge;
a burner for converting the partially dewatered sludge into an ash comprising inorganic materials in an amount of at least about 80% by weight of the ash; and
a pyrolyzer configured to pyrolyze a mixture of the plastic portion and at least a portion of the ash.

15. The system of claim 14, wherein the fiber recovery system comprises a rotoclave for separating the plastic portion and the fiber portion from the waste fiber supply.

16. The system of claim 14, wherein the fiber recovery system comprises a cleaner, deinker, clarifier, or a combination thereof.

17. The system of claim 14, wherein the fiber recovery system comprises a separator for removing short fibers and inorganic materials not fixed to long fibers, the long fibers being suitable for use in one or more recycled paper products.

18. The system of claim 14, wherein the means for at least partially dewatering the sludge portion comprises a mechanical press.

19. The system of claim 14, further comprising a grinder for reducing an average diameter of the ash.

20. The system of claim 14, further comprising one or more boilers for converting one or more byproducts of the integrated recycling system into energy.
